(19) United States
(12) Patent Application Publication
(10) Pub. No.: US 2026/0085231 A1
(43) Pub. Date: Mar. 26, 2026

(54) DRAG REDUCING POLYALPHA OLEFIN SLURRY AND METHODS OF MAKING AND USING THE SAME

(71) Applicant: FLOWCHEM LLC, Waller, TX (US)

(72) Inventors: John C. STEPHENS SAMUDIO, Beaver Falls, PA (US); Trevor QUICK, Houston, TX (US); Muhammad Ejaz, Houston, TX (US); Kevin DONOVAN, Bergen, NY (US); Deepak SHUKLA, Rochester, NY (US); Ramprasad KAMISETTY, Katy, TX (US)

(21) Appl. No.: 19/114,100

(22) PCT Filed: Sep. 22, 2023
(86) PCT No.: PCT/US2023/033528

§ 371 Date: Mar. 21, 2025

Related U.S. Application Data
(60) Provisional application No. 63/409,094, filed on Sep. 22, 2022.

(51) Int. Cl. C09K 8/584; C09K 8/588

(52) U.S. Cl. CPC C09K 8/584; C09K 8/588; C09K 2208/28

(57) ABSTRACT

Drag reducing slurries and methods of making and using the same are disclosed herein. In some embodiments, a drag reducing slurry includes polymer particles having drag reducing properties, each particle having a surface that has at least two different polarities, a first surfactant, a second surfactant, a rheological modifier, a defoamer, a pH modifier, and a carrier fluid, wherein the first surfactant has a higher polarity than the second surfactant. In some embodiments, the slurry has a low shear viscosity, measured at 1 Hz, of less than 10,000 centipoise (cP), a tan δ of less than or equal to 0.5, a complex viscosity less than 100,000 mP·s, and a stability of at least 90 days.

### CROSS-REFERENCE TO RELATED APPLICATIONS

This disclosure claims priority from U.S. Provisional Patent Application No. 63/409,094, the contents of which are incorporated by reference herein.

### TECHNICAL FIELD

This disclosure generally relates to hydrocarbon recovery, and more specifically to a drag reducing slurry and methods of making and using the same.

### BACKGROUND

Hydrocarbon transportation pipelines transport liquid hydrocarbons, such as crude oil, between different locations. Drag-reducing agents (DRAs) are used to reduce the effect of friction (“drag”) experienced by the liquid hydrocarbon flowing through the pipelines. A reduction of the drag decreases the amount of energy needed to cause the hydrocarbon to flow, and therefore also decreases costs associated with transporting liquid hydrocarbons.

Polymer particles can be effective DRAs. One such polymer particles are polyalphaolefin (PAOs). DRAs may be introduced as solid particles to a hydrocarbon pipeline. The polymer particles dissolve in the hydrocarbon and act as a DRA. Unfortunately, DRAs, particularly PAOs are difficult to prepare in a stable form, such as in a slurry, that can be reliably stored, transported, and introduced into a hydrocarbon pipeline for hydrocarbon recovery. For example, slurries of PAO particles that have previously been prepared suffer from certain drawbacks and disadvantages. For instance, previous slurries of PAO particles suffer from PAO particle agglomeration, even if stored at cold temperatures, resulting in particle aggregation over time and an inability to effectively pump the slurry into a hydrocarbon pipeline because the aggregated particles are difficult to transport and have degraded effectiveness even if they reach the hydrocarbon. In addition, previous slurries of PAO particles are susceptible to particle agglomeration with increasing temperature and/or extended periods of elevated temperatures. Previous PAO slurries also require the use of high-cost components, such as an oil-based carrier fluid, for example, as described in U.S. Pat. No. 9,267,094.

Accordingly, there is a need in the art for improved drag reducing slurries.

### BRIEF SUMMARY

Drag reducing slurries and methods of making and using the same are disclosed herein. In some embodiments, a drag reducing slurry includes polymer particles having drag reducing properties, each particle having a surface that has at least two different polarities, a first surfactant, a second surfactant, a rheological modifier, a defoamer, a pH modifier, and a carrier fluid, wherein the first surfactant has a higher polarity than the second surfactant. In some embodiments, the slurry has a low shear viscosity, measured at 1 Hz, of less than 10,000 centipoise (cP), a tan δ of less than 0.5, a complex viscosity less than 100,000 mP·s, and a stability of at least 90 days.

In some embodiments, a method of reducing drag in a pipeline carrying hydrocarbons includes injecting the drag reducing slurry into a pipeline, the pipeline having hydrocarbons flowing therethrough.

### BRIEF DESCRIPTION OF FIGURES

To assist in understanding the present disclosure, reference is now made to the following description taken in conjunction with the accompanying drawings, in which:

FIG. 1 depicts a block diagram of components in a drag reducing slurry in accordance with some embodiments of this disclosure.

FIG. 2 depicts a frequency sweep in accordance with some embodiments of the disclosure.

FIG. 3 depicts a viscosity curve in accordance with some embodiments of the disclosure.

FIG. 4 depicts an amplitude sweep in accordance with some embodiments of the disclosure.

### DETAILED DESCRIPTION

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The use of the terms “a” and “an” and “the” and similar referents in the context of describing the invention (especially in the context of the following statements) are to be construed to cover both the singular and the plural, unless otherwise indicated herein or clearly contradicted by context. As used in this document, “each” refers to each member of a set or each member of a subset of a set. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. Moreover, recitation of a range such as “of A to B”, or “from A to B”, or “between A to B”, or any recitation of range is intended to include the endpoints A and B. The use of any and all examples, or exemplary language (e.g., “such as”) provided herein, is intended merely to better explain the disclosure and does not pose a limitation on the scope of statements.

This disclosure provides a drag reducing slurry that may be advantageously more uniform, stable, and/or pumpable over time than those previously available. The drag reducing slurries may include a carrier fluid, a rheology modifier, a first surfactant and a second surfactant, a defoamer, a pH modifier, and particles (e.g., PAO particles). The drag reducing slurries may have a pH between 6 and 11, a low shear viscosity (measured at 1 Hz) less than 10,000 centipoise (cP), a tan delta (tan δ) of less than or equal to 0.5, and a complex viscosity less than 100,000 mP·s, and stability of at least 90 days. In some embodiments, the slurries may have pH between 6 and 11, a low shear viscosity (measured at 1 Hz) between 2,000 and 8,000 cP, tan δ of between 0.15 and 0.4, preferably between 0.2 to 0.5, and a complex viscosity between 10,000 and 70,000 mP·s, and stability of over 130 days. The drag reducing slurries may be pumpable and resistant to agglomeration when exposed to acute temperature increases above 120° F. and prolonged exposure to temperatures above 32° F. for an extended period. In some embodiments, the slurries may be effective at prolonged exposure to temperatures above 100° F., or up to about 120° F., but rheological properties and stability may be degraded in comparison to prolonged exposure at lower temperatures.

### Drag Reducing Slurry

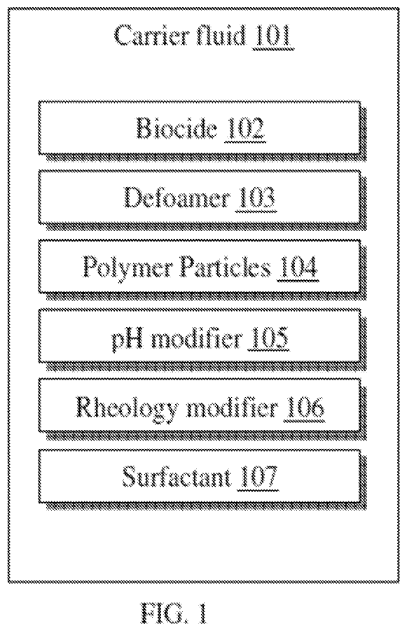

FIG. 1 depicts a drag reducing slurry 100 in accordance with some embodiments of the disclosure. The drag reducing slurry 100 may be used as a DRA for hydrocarbon recovery. The drag reducing slurry 100 includes a carrier fluid 101, a defoamer 103, polymer particles 104, a pH modifier 105, a rheology modifier 106, at least two surfactants 107, and a biocide 102. Though slurry 100 includes a biocide and pH modifier, slurries of the disclosure may optionally include a biocide and/or pH modifier.

The drag reducing slurry 100 may function as a DRA when injected in a hydrocarbon pipeline. Moreover, prior to being injected into a pipeline, the drag reducing slurry 100 may exhibit an improved shear stability over time compared to that of previous DRA slurries, which tend to suffer from particle agglomeration and poor performance after being stored for some period of time. The drag reducing slurry 100 may further include one or more additional components, such as a salt, an electrolyte, and the like.

The carrier fluid 101 can vary based on environmental factors. For example, for temperatures, such as between about 10° F. to about 100° F. the carrier fluid may include water, water-soluble solvents, such as alcohols, or a combination thereof. The water-soluble solvents may be included to lower the freezing point of the carrier fluid. However, water-soluble solvents may be included (in addition to water) in the carrier fluid at temperatures above this range but may be less stable due to similarities between the water-based solvent and the surfactants being used. In some embodiments, such as near the freezing point of water or below, the carrier fluid may consist or consist essentially of the water-soluble solvent. In some embodiments, at high temperatures, for example, at 32° F. or above, the carrier fluid may consist or consist essentially of water.

The carrier fluid 101 comprises water, a water-soluble solvent, or a combination thereof. The carrier fluid is preferably homogenous. Accordingly, when water and a water-soluble solvent are used in combination, the water-soluble solvent is selected and/or used in an appropriate amount such that homogeneity of the carrier fluid is maintained. The slurry 100 includes the carrier fluid 101 in an amount ranging from about 50 percent by weight (wt %) to about 80 wt %, based on the total weight of the slurry 100. The carrier fluid 101 may include water in an amount ranging from 0 wt % to 100 wt %, based on the total weight of the carrier fluid 101. In some embodiments, the carrier fluid may include water in an amount ranging from about 40 wt % to about 90 wt %, or from about 50 wt % to about 80 wt %, or from about 50 wt % to about 70 wt %, based on the total weight of the carrier fluid 101. The carrier fluid may include a water-soluble solvent in an amount ranging from 0 wt % to 100 wt %. In some embodiments, the carrier fluid may include a water-soluble solvent in an amount ranging from about 5 wt % to 50 wt %, based on the total weight of the carrier fluid 101. In some embodiments, the carrier fluid may include a water-soluble solvent in an amount ranging from about 5 wt % to 30 wt %, based on the total weight of the carrier fluid 101.

Exemplary water-soluble solvents include water soluble alcohols, such as propylene glycol, ethylene glycol, and glycol ether. Commercially available water soluble alcohols include DOWANOL™ PM, DOWANOL™ PnP, DOWANOL™ PnB, DOWANOL™ DPnB, DOWANOL™ PPh, Butyl CELLOSOLVE™ solvent, DOWANOL™ PMA, DOWANOL™ PGDA, PROGLYDE™ DMM, available from the Dow Chemical Company. Water-soluble solvents used in the carrier fluid 101 may preferably have a boiling point higher than 100° C. and have a solubility in water of at least 5 wt %.

Biocide 102 may be included in the slurry 100 to prevent bacterial growth and/or as a preservative. Exemplary biocides include, but are not limited to, chlorothalonil, iodopropynyl butylcarbamate (IPBC), octyl isothiazolone, zinc pyrithione, heterocyclic N, S compounds and N-haloalkyl thiol compounds, water-soluble polyoxymethylenes such as DOWICIL™, available from the Dow Chemical Company, PROXEL™ BD, available from ICI Americas Inc., glutaraldehyde, a glutaraldehyde/quaternary ammonium compound blend, isothiazolin, tetrakishydromethyl phosphonium Sulfate (THPS), 2,2-dibromo-3-nitrilopropionamide, bronopol, and mixtures thereof, and Polyphase® and Mergal® preservatives sold by Troy Corporation. The biocide 102 may be present in the slurry 100 in an amount ranging from about 0.01 wt % to about 10 wt %, based on the total weight of the slurry 100.

Defoamer 103 destroys foam bubbles and/or prevent foam bubbles from forming. The defoamer may also be known as an antifoam or air releasing agent. By inhibiting the formation of bubbles trapped in and around polymer particles 104 by the defoamer 103, the surfactant 107 is able to disperse and stabilize polymer particles 104. In addition, the defoamer 103 enhances pumpability, thermal stability, and/or storage stability for the slurry 100 by reducing the incorporation of air and inhibiting the formation of a layer of foam that accelerates the dehydration of the slurry 100.

Exemplary defoamers include, but are not limited to 2-octanol, oleic acid, paraffinic waxes, amide waxes, sulfonated oils, organic phosphates, silicone oils, mineral oils, and polydimethylsiloxanes. Commercially available defoamers include silicone defoamers, mineral oil defoamers and polymer defoamers, available from BYK Additives, such as BYK 011, BYK 030, and BYK 1707. Other commercially available defoamers include polypropylene glycols (PPGs) and EO/PO copolymers, such as XIAMETER™, DOWSIL™, and UCARSOL™, which are available from the Dow Chemical Company.

The defoamer 103 may be present in the slurry 100 in an amount ranging from 0.01 wt % to 10 wt %, based on the total weight of the slurry 100. In some embodiments, the defoamer may range from about 0.2 wt % to about 1.0 wt %.

The polymer particles 104 have good performance as a DRA. The polymer particles 104 may be soluble in light and/or medium crude oil. The polymer particles 104 may be prepared by cryo-grinding a solid piece of a polymer material Methods and catalysts used in the preparation of drag-reducing polymers useful in the present invention are disclosed in the following U.S. Pat. Nos. 4,289,679; 4,358,572; 4,415,704; 4,433,123; 4,493,903; and 4,493,904, all of which are incorporated herein by reference. Polymers used in the drag reducing compositions of the present invention can be produced by a so-called solution polymerization technique, or by bulk polymerization methods as described, for example, in U.S. Pat. No. 5,539,044, the disclosure of which is incorporated herein by reference.

In some embodiments, the polymer particles 104 are particles of a PAO homopolymer or copolymer. Exemplary PAO homopolymers include, but are not limited to, polybutene-1, polyisobutene, polyhexene-1, polyoctene-1, polydecene-1, polyhexadecene-1 and polyeicosene-1. Typical PAO copolymers are propene-dodecene-1 copolymer, butene-1-dodecene-1 copolymer, butene-1-decene-1 copolymer, hexene-1-dodecene-1 copolymer, octene-1-tetradecene-1 copolymer, butene-1-decene-1-dodecene-1 copolymer, propene-hexene-1-dodecene-1 copolymer, etc. Preferred polymers are polyhexene-1, polyoctene-1, polydecene-1, polydodecene-1, polytetradecene-1, propene-dodecene-1 copolymer, butene-1-decene-1 copolymer, butene-1-dodecene-1 copolymer, decene-1-dodecene-1 copolymer and hexene-1-dodecene-1 copolymer.

Any type of polymer having drag reducing properties can be utilized in the slurries disclosed herein. Other exemplary polymers having drag reducing properties include acrylates.

The polymer particles 104 may be relatively large in size, such that it may be difficult to obtain a stable mixture of the polymer particles 104 dispersed in the carrier fluid 101 alone. For example, the polymer particles 104 may include particles with mass-median-diameters (D50) in a range from about 50 micrometers (μm) to 750 μm, or in some embodiments, from about 100 μm to about 250 μm. The D50 diameters may be measured, for example, using particle size analyzer, such as a Microtrac Flowsync, available from Microtrac MRB. In some embodiments, the particle distribution may fall within about 200 μm to about 400 μm of the D50 value.

The polymer particles 104 may be coated with a partitioning agent to help limit or prevent agglomeration and/or caking of the polymer particles 104 before they are added to the carrier fluid 101. The one or more various agents may form a coating covering the polymer particles 104. In some embodiments, the coating may partially cover each polymer particle, such that the polymer particle and the coating have a core-shell structure (e.g., polymer particle core and coating shell), where the surface of a coated polymer particle has at least two different polarities. For example, a first area of the surface of each polymer particle may be covered by the coating and a second area may be an exposed surface of the underlying polymer particle. The first area may have a higher polarity that the second area. In some embodiments, the partitioning agent may be used in amounts ranging from about 5 wt % to about 30 wt %, based on the total weight of the polymer particles 104.

A partitioning agent may be one or more selected from the group consisting of fatty acid waxes (to be distinguished herein from the fatty acid waxes included in the pre-treatment of the dispersion including a fatty acid wax and a liquid carrier), polyolefin homopolymers and copolymers of various densities; oxidized polyethylene; polystyrene and copolymers; carbon black and graphite; precipitated and fumed silicas; natural and synthetic clays and organo-clays; metallic salts of fatty acids such as aluminum stearate, calcium stearate, magnesium stearate, potassium stearate, sodium stearate, zinc stearate; ethylene bis-stearamide, stearamide, ethylene glycol monostearate, ethylene glycol distearate, propylene glycol monostearate, propylene glycol distearate, glycerol stearate, glycerol distearate, glycerol tristearate, diethylene glycol distearate, stearic anhydride, and combinations thereof; naturally occurring waxes such as bees wax, polyethylene waxes, polypropylene waxes, methylene waxes, aluminum oxides; talc; boric acid; polyanhydride polymers; sterically hindered alkyl phenol oxidants; magnesium, calcium and barium phosphates, sulfates, carbonates and oxides; mixtures thereof; and the like. The polymer particles 104 are generally readily soluble in light or medium crude oils.

The slurry 100 may include the polymer particles 104, coated or uncoated, in an amount ranging from 0.05 wt % to 75 wt %, based on the total weight of the slurry 100. In some embodiments, the polymer particles 104 are present in an amount ranging from 0.1 wt % to 50 wt %, based on the total weight of the slurry 100. In some embodiments, the polymer particles 104 are present in an amount ranging from 25 wt % to 45 wt %, based on the total weight of the slurry 100.

The pH modifier 105 may assist in controlling bacterial growth, and/or enhance stability of the slurry 100, which can provide a safer material for shipping and handling. The pH modifier includes, but is not limited to, one or more of strong acids, strong bases, weak acids, weak bases, buffers, organic and inorganic salts (e.g., hydrochloric acid, acetic acid, monopotassium phosphate, dipotassium phosphate, ammonium chloride, sodium hydroxide, triethylamine, ammonium hydroxide, sodium acetate, phenol).

The pH modifier may enhance stability of the slurry 100 by creating a stable environment for the surfactant 107. For example, surfactants may be sensitive to strong bases or strong acids. Further, surfactants may denature at high temperatures. The slurry 100 may be controlled by the pH modifier to have a pH ranging from about 6 to about 11. In some embodiments, the pH may range from about 8 to about 10, or from about 9 to about 10. In some embodiments, a pH above 12 or at 7 or below can result in an unstable slurry.

The slurry 100 may include the pH modifier in an amount ranging from 0.05 wt % to 25 wt %.

The rheology modifier 106 may increase the viscosity of the slurry 100. For example, the viscosity of the slurry 100 with the rheology modifier 106 is greater than that of the carrier fluid 101 alone. The rheology modifier 106 may slow the rate of separation of the relatively low-density polymer particles 104 from the higher density carrier fluid 101, for example, due to particle buoyancy.

The rheology modifier 106 may include, but are not limited to, one or more of sugars and synthetic polymers. For example, the rheology modifier 106 may include one or more polysaccharides. The polysaccharides may include celluloses and/or their derivatives, such as carboxymethyl cellulose (CMC), hydroxethyl cellulose (HEC), carboxymethyl hydroxethyl cellulose (CMHEC), hydroxypropyl cellulose, sulfoethyl cellulose and its derivatives, ethyl hydroxyethyl cellulose (EHEC), methyl ethyl hydroxyethyl cellulose (MEHEC), and hydrophobically modified ethyl hydroxyethyl celluloses HM-EHEC, some of which are available from AkzoNobel. Polysaccharides also include cellulosic derivatives, including plant heteropolysaccharides commonly known as hemicelluloses which are by-products of the paper and pulp industry. Hemicelluloses include xylans, glucuronoxylans, arabinoxylans, glucomannans, and xyloglucans. Xylans are the most common heteropolysaccharide and are preferred in certain embodiments. Polysaccharides also include inulin and its derivatives, such as carboxymethyl inulin. In an embodiment, the preferred cellulose materials are carboxymethyl cellulose (CMC), hydroxethyl cellulose (HEC), carboxymethyl hydroxethyl cellulose (CMHEC), hydroxypropyl cellulose, ethyl hydroxyethyl cellulose (EHEC), methyl ethyl hydroxyethyl cellulose (MEHEC), and hydrophobically modified ethyl hydroxy ethyl celluloses (HM-EHEC).

In certain embodiments, the polysaccharides are gums and gum derivatives. Examples of gums suitable for use in this disclosure include, without limitation, agar, alginic acid, beta glucan, carrageenan, chicle gum, dammar gum, diutan gum, gellan gum, guar gum, gum arabic, gum ghatti, gum tragachanth, karava gum, locust bean gum, mastic gum, psyllium seed husks, sodium alginate, spruce gum, tara gum, xanthan gum, or combinations thereof.

The rheology modifier 106 may include a homopolymer or a copolymer of an olefinically unsaturated carboxylic acid or anhydride monomers containing at least one activated carbon to carbon olefinic double bond and at least one carboxyl group or an alkali soluble acrylic emulsion, or an associative thickener or stabilizer, such as a hydrophobically modified alkali soluble acrylic emulsion or a hydrophobically modified nonionic polyol polymer (e.g., a hydrophobically modified urethane polymer, or combinations thereof). Homopolymers of polyacrylic acid are described, for example, in U.S. Pat. No. 2,798,053. Examples of homopolymers which are useful include Carbopol® 934, 940, 941, Ultrez 10, ETD 2050, and 974P polymers, which are available from The B.F. Goodrich Company. Such polymers are homopolymers of unsaturated, polymerizable carboxylic monomers such as acrylic acid, methacrylic acid, maleic acid, itaconic acid, maleic anhydride, and the like. Hydrophobically modified polyacrylic acid polymers are described, for example, in U.S. Pat. Nos. 3,915,921, 4,421,902, 4,509,949, 4,923,940, 4,996,274, 5,004,598, and 5,349,030, which are incorporated by reference herein. Useful polymers as rheological modifiers are sold as Carbopol® 1342 and 1382 and Pemulen® TR-1, TR-2, 1621, and 1622, all available from The B.F. Goodrich Company.

Hydrophobically modified urethane polymers can also be used as the rheology modifier 106. Examples of such polymer are disclosed in E.P. 2,444,432 B1. The rheology modifier 106 can be associative thickeners or stabilizers, such as a hydrophobically modified alkali soluble acrylic emulsion or a hydrophobically modified nonionic polyol polymer (e.g., a hydrophobically modified urethane polymer, or combinations thereof). Examples of such associative thickeners are disclosed in European Patent Application No. 0978522 A1. Associative thickeners are commercially available from BYK Additives and Instruments (e.g., Rheobyk-H 6500).

The rheology modifier 106 includes, but is not limited to, one or more of guar gum, diutan gum, welan gum, Rheobyk-H-6500 VF, available from BYK.

The slurry 100 may include the rheology modifier 106 in an amount ranging from 0.05 wt % to 10 wt %, based on the total weight of the slurry 100. In some embodiments, the rheology modifier 106 may be present in an amount ranging from 0.5 wt % to 5 wt %, based on the total weight of the slurry 100. In some embodiments, the rheology modifier 106 may be present in an amount ranging from 0.07 wt % to 0.11 wt %, based on the total weight of the slurry 100.

The surfactant 107 may aid in maintaining stable dispersion of the polymer particles 104 in the carrier fluid 101. The surfactant 107 may be uniquely tailored to complement the coated polymer particles 104 while aiding in dispersing and stabilizing the particles in the carrier fluid 101. For example, the surfactant helps prevent agglomeration of polymer particles 104 and/or separation of the polymer particles 104 from the carrier fluid 101.

The surfactant 107 may include at least two surfactants. In some embodiments, the surfactant 107 may include a first surfactant and a second surfactant. The first surfactant may have a higher polarity that the second surfactant such that the first surfactant contacts the first area of the surface of a coated polymer particle 104 and the second surfactant contacts the second area of the surface of a coated polymer particle 104.

The first and second surfactants may, independently, have a hydrophilic-lipophilic balance (HLB) value ranging from 4 to 15. In some embodiments, the first surfactant may have an HLB value ranging from about 12 to about 15. In some embodiments, the second surfactant may have an HLB value ranging from about 6 to about 9. The combined HLB value of the surfactant 107 may range from about 10 to about 12. The ‘combined HLB value’, is a weighted average of the HLB values of the individual surfactants being used. For example, in a slurry having a surfactant A in an amount of x and a surfactant B in an amount of y, where x+y=total weight of surfactant in slurry, the ‘combined HLB’ equals (x/(x+y)) (HLB value of surfactant A)+(y/(x+y)) (HLB value of surfactant B). Calculation of the combined HLB valued can further be found in “The HLB System: A Time-Saving Guide to Emulsifiers Selection” ICI Americas Inc., Wilmington, Delaware, 1976. For example, one or more additional surfactants can be utilized as necessary depending on the surface of the coating polymer particle. For example, a third surfactant may be combined with the second surfactant to better cover the second surface, a fourth surfactant may be combined with the first surfactant to better cover the first surface, or the like.

The surfactant 107 may include ionic surfactants, non-ionic surfactants, or a mixture thereof. Ionic surfactants can be anionic or cationic. The anionic surfactants include, but are not limited thereto, surfactants having various substituted or unsubstituted hydrocarbyl chains or substituted or unsubstituted heterogeneous chains, for example, substituted or unsubstituted hydrocarbyl chain lengths, such as about C₈ to C₂₂, about C₁₀ to C₁₈, or C₁₂ to C₁₆; those skilled in the art will recognize that the final chain length will be determined by the slurry composition. Typical chains are alkyl, alkoxyalkyl, alkylaryl, or alkylamidoalkyl. Sulfonates, sulfates, carboxylates, and phosphates, can be used as anionic surfactants. Exemplary anionic surfactants include, but are not limited thereto, sodium dodecyl sulfate (SDS), sodium dodecylbenzene sulfonate (SDBS), sodium decylsulfate (SdeS), sodium octyl sulfate (SOS), ammonium ether sulfate (e.g., Cedepal™ FA-406), or a mixture thereof. Suitable sulfonate surfactants for use herein include water-soluble salts of C₈-C₁₈ alkyl or hydroxyalkyl sulfonates; C₁₁-C₁₈ alkyl benzene sulfonates (LAS), modified alkylbenzene sulfonate (MLAS), aryl sulfonates based surfactants (e.g., Calfax 16L-35 manufactured by Pilot Chemical Company); methyl ester sulfonate (MES); and alpha-olefin sulfonate (AOS). The surfactant 107 may include paraffin sulfonates such as monosulfonates and/or disulfonates, obtained by sulfonating paraffins of 10 to 20 carbon atoms. Sulfonate surfactants may include alkyl glyceryl sulfonate surfactants. Others anionic surfactants include polyelectrolytes such as alkali metal polyelectrolytes, such as sodium polyelectrolytes, more particularly, polystyrene sulfate or polyacrylates, or styrene maleic acid copolymers (e.g., Disperbyk 190, available from BYK).

Cationic surfactants include ammonium surfactants, substituted ammonium surfactants such as alkyl substituted ammonium surfactants, quaternary ammonium surfactants (e.g., Arquads™), pyridinium surfactants, or substituted pyridinium surfactants such as alkyl substituted pyridinium surfactants, are some examples that can be used herein. Some specific examples of cationic surfactants include, but are not limited to, octyltrimethylammonium bromide (OTAB), decyltrimethylammonium bromide (DeTAB), dodecyltrimethylammonium bromide (DTAB), tetradecyltrimethylammonium bromide (TTAB), hexadecyltrimethylammonium bromide (HTAB), tetradecylpyridinium bromide (Ci4PyBr), cetylpyridinium bromide (Ci6PyBr), decyltriphenylphosphonium bromide (DeTPPB), dodecyltriphenylphosphonium bromide (DTPPB), hexamethylene-Bis-[N,N-dimethylammonium] bromide (12-6-12), pentamethylene-Bis-[N,N-dimethylammonium] bromide (12-5-12), or a mixture thereof. In certain embodiments, a cationic surfactant having a single tailed cationic surfactant with a quaternary ammonium head group like OTAB, DTAB, tec. Is preferred.

Non-ionic surfactants include, but are not limited to, condensation products of alkyl phenols with ethylene oxide. Commercially available nonionic surfactants of this type include Igepal CO-630, marketed by the GAF Corporation, and Triton X-45, X-1 14, X-100, and X-102, all marketed by the Dow Chemical Company. Other examples of nonionic surfactants included in the dispersant(s) 107 are condensation products of aliphatic alcohols with from about 1 to about 25 moles of ethylene oxide. Examples of commercially available nonionic surfactants of this type include Tergitol 15-S-9 (marketed by Union Carbide Corporation); Neodol 45-9, Neodol 23-6.5, Neodol 45-7 Neodol 45-4 marketed by Shell Chemical Company, and Kyro EOB marketed by The Procter & Gamble Company.

Other examples of non-ionic surfactants are condensation products of ethylene oxide with a hydrophobic base formed by the condensation of propylene oxide with propylene glycol. Examples of compounds of this type include commercially available Pluronic surfactants, available from BASF. Preferred examples are Pluronics F-127, Pluronic L35, Pluronic P105, etc. Other examples of nonionic surfactants included in the surfactant 107 are the condensation products of ethylene oxide with the product resulting from the reaction of propylene oxide and ethylenediamine. Examples of this type of nonionic surfactant include certain of the commercially available Tetronic compounds, marketed by BASF. Yet other examples of nonionic surfactants included in the surfactant 107 are surfactants derived from sorbitan esters, commonly called Span®, and surfactants derived from ethoxylation (or polyoxyethylene) of sorbitan esters called Tween® (available from Croda) are also useful in practice of the current invention.

The surfactant 107 may be present in the slurry 100 in an amount ranging from 0.01 wt % to 5 wt %, based on the total weight of the slurry 100. In some embodiments, the surfactants 107 are present in an amount ranging from 0.01 wt % to 2 wt %, based on the total weight of the slurry 100.

In some embodiments, the surfactant includes the first surfactant and second surfactant. The first surfactant may be present in the slurry 100 in an amount ranging from 0.1 wt % to 1.0 wt %, based on the total weight of the slurry 100. The second surfactant may be present in the slurry 100 in an amount ranging from 0.1 wt % to 1.0 wt %, based on the total weight of the slurry 100. In some embodiments, the first surfactant to the second surfactant may be present in a weight ratio of 1:5 to 5:1.

### Method of Making a Slurry

A method of making a slurry may include mixing a defoamer in a carrier fluid to form a mixture. One or more surfactants may next be added to the mixture. The mixture may be stirred as necessary to homogenize the defoamer and surfactants in the carrier fluid. Polymer particles may be added to the mixture, followed by stirring to form a dispersion of the particles in the mixture. Rheological modifier, pH modifier, and optionally, biocide, may be added and stirred as necessary to form a slurry.

### Method of Reducing Drag in a Pipeline

A method of reducing drag in a pipeline carrying hydrocarbons, comprising: injecting the drag reducing slurry of into a pipeline, the pipeline having hydrocarbons flowing therethrough. Methods of reducing drag in pipelines are well know in the art, for example, in U.S. Pat. No. 9,267,094, which is incorporated by reference herein.

TABLE 1
Formulations (weight %)

| | | Examples/Comparative Examples | | | | | | | | | | |
|---|---|---|---|---|---|---|---|---|---|---|---|---|
| | | | | | | | | | | | Comp | Comp |
| | | Ex 1 | Ex 2 | Ex 3 | Ex 4 | Ex 5 | Ex 6 | Ex 7 | Ex 8 | Ex 9 | Ex 1 | Ex 2 |
| Carrier Fluid | Water | 61.26 | 63.91 | 60.18 | 32.08 | 64.05 | 64.30 | 44.27 | 60.46 | 64.16 | 61.92 | 58.04 |
| | Ethylene glycol | — | — | — | 32.08 | — | — | — | — | — | | |
| | Propylene glycol | — | — | — | — | — | — | 19.89 | — | — | | |
| Defoamer | BYK 015 | 0.50 | 0.75 | 0.50 | 0.50 | 0.50 | 0.50 | 0.50 | 0.50 | — | | 1.05 |
| | BYK 014 | — | — | — | — | — | — | — | — | 0.50 | | |
| Surfactant(s) | Tergitol 15-S-9 | 0.50 | 0.50 | 1.20 | 0.50 | 0.50 | 0.50 | 0.50 | 0.50 | 0.50 | 0.2 | 0.21 |
| | Span 80 | 0.12 | 0.12 | — | 0.12 | 0.12 | 0.12 | 0.12 | 0.12 | 0.12 | | |
| | SDBS | — | — | 0.50 | — | — | — | — | — | — | | |
| | Hypermer 1599 | — | — | — | — | — | — | — | 0.80 | — | | |
| | Soybean Oil | — | — | — | — | 0.10 | — | — | — | — | | |
| | Pluronic F-127 | | | | | | | | | | 0.5 | 0.53 |
| Polymer Particles | Cryopowder | 37.00 | 34.00 | 37.00 | 34.00 | 34.00 | 34.00 | 34.00 | 37.00 | 34.00 | 37.00 | 38.84 |
| Rheology Modifier | Diutan Gum | 0.08 | 0.10 | 0.08 | 0.10 | 0.08 | 0.08 | 0.10 | 0.08 | 0.10 | 0.08 | 0.51 |
| pH Modifier | Monopotassium | 0.44 | — | 0.44 | — | — | 0.40 | — | 0.44 | — | | 064 |
| | phosphate | | | | | | | | | | | |
| | Sodium bicarbonate | — | 0.52 | — | 0.52 | 0.55 | — | 0.52 | — | 0.52 | | |
| Biocide | Mergal 174II | 0.10 | 0.10 | 0.10 | 0.10 | 0.10 | 0.10 | 0.10 | 0.10 | 0.10 | 0.30 | 0.11 |
| Combined HLB | | 11.6 | 11.6 | 12.5 | 11.6 | 10.9 | 11.6 | 11.6 | 8.1 | 11.6 | 19.5 | 19.5 |
| Value* | | | | | | | | | | | | |

*Combined HLB value is the weighted average of the HLB values of the individual surfactants.

### EXPERIMENTAL EXAMPLES

### Example 1

Example 1 was prepared according to the following procedure. A defoamer, BYK 015, (5.0 g) is added to carrier fluid, water (602.6 g). After stirring for 15 minutes, surfactants, Tergitol 15-S-9 (5.0 g) and Span 80 (1.2 g), are added to the mixture. After stirring the preceding mixture, polymer particles (370.0 g, amorphous solid poly(l-decene) coated with 22 wt % calcium stearate) are added and vigorously stirred with a Cowles blade for at least 30 minutes or until fully incorporated. After 30 minutes, rheology modifier, diutan gum, (0.8 g), and pH modifier, monopotassium phosphate, (4.4 g) is added while stirring. After an additional 30 minutes of stirring, biocide, Mergal® 174II, (1.0 g) is added. This final viscoelastic dispersion is complete after mixing for an additional 30 minutes.

Example 1 had a pH of 10.4 after 222 days. The slurry was homogenous as determined by visual inspection. The rheological properties of Example 1 (at 222 days) were evaluated using a rheometer (Anton Paar MCR 501 rheometer) at 25° C. The results are shown in Table 2.

### Examples 2 to 8

Examples 2 to 8 are prepared and tested in the same manner as Example 1, except with compounds and amounts as shown in Table 1 above. The results of Examples 2 to 8 are shown in Table 2.

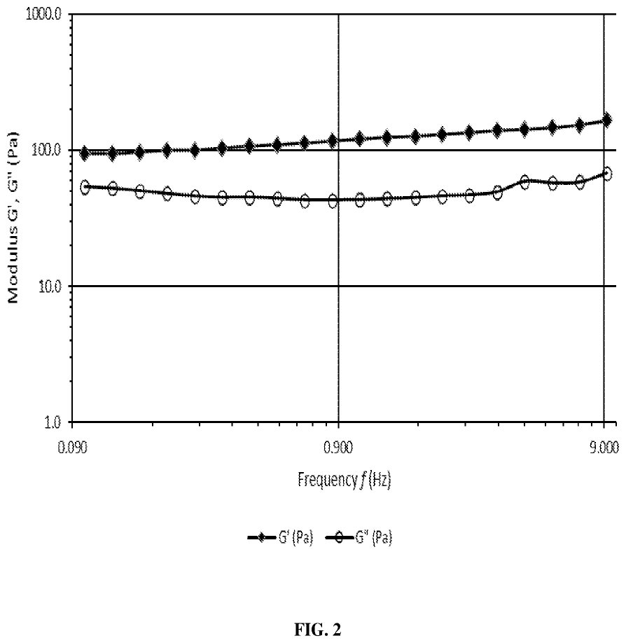

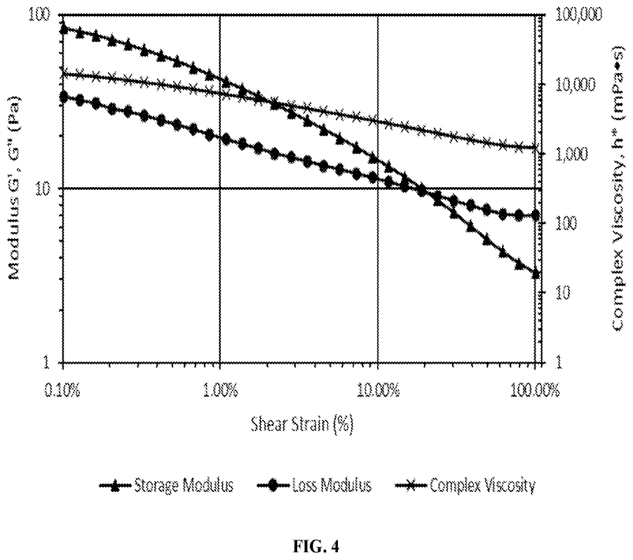

The results of Example 8 are further described in FIGS. 2 to 4.

FIG. 2 is a frequency sweep of Example 8, measured at 212 days. The frequency sweep is used to calculate the tan δ of Example 8. Even after 212 days in storage, the slurry continues to display tan δ that are within the desired ranges for application and stable. By stable, it is meant that the rheological parameters are not changing much, relative to day zero, and the slurry does not separate or agglomerate based on visual inspection.

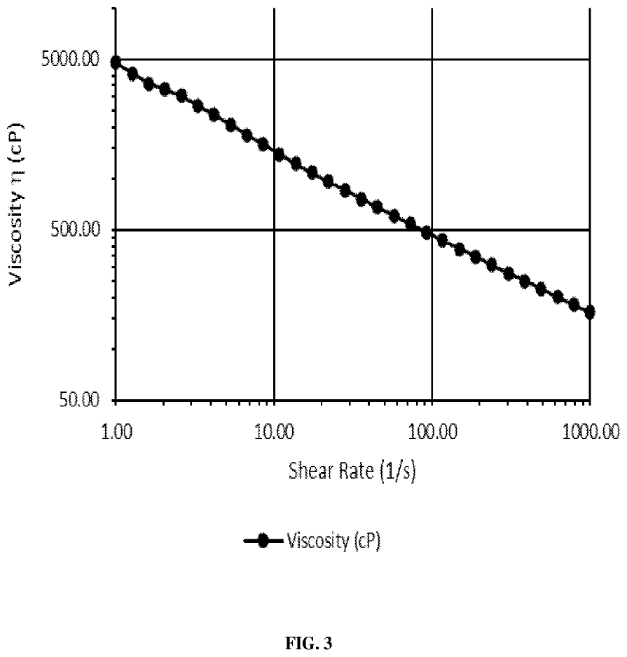

FIG. 3 is a viscosity curve of Example 8, measured at 212 days. The viscosity curve shows low shear viscosity of Example 8 and demonstrates that it retains non-Newtonian, shear thinning properties of a viscoelastic fluid. Even after 2012 days in storage, the slurry continues to display rheological parameters (low shear viscosity) that are within our desired ranges for application and stable. Maintaining a desired viscosity range ensures proper dispersion, stabilization, and pumpability.

FIG. 3 is an amplitude sweep of Example 8, measured after 212 days. The amplitude sweep shows that the crossover point (where the loss factor equals one) occurs at a point greater than a critical strain (shear strain) of 1%. This result suggests that the slurry remains a sterically stabilized system (where steric stabilization dominates instead of ionic stabilization), necessary for long term dispersion and stability. Even after 212 days in storage, the slurry continues to display rheological parameters (shear strain) that is within desired ranges for application and stable.

### Comparative Examples 1 to 2

Comparative Examples 1 to 2 are prepared and tested in the same manner as Example 1, except with compounds and amounts as shown in Table 1 above. The results of Comparative Examples 1 to 2 are shown in Table 2.

Comparative Example 1, missing a defoamer and pH modifier, and having a combined HLB value of the surfactants being 19.5, was stable for less than two weeks, showing phase separation upon visual inspection. Further, low shear viscosity and complex viscosity were outside the desired range. Comparative Example 2, having a combined HLB value of the surfactants of 19.5, was unstable, showing agglomeration upon visual inspection after 28 days. In field testing, comparative example 2 agglomerated and was eventually unable to be pumped. Further, Comparative Example 2 also had low shear viscosity and complex viscosity outside the desired range.

TABLE 2
Long term stability

| | Example/Comparative Examples | | | | | | | | | | |
|---|---|---|---|---|---|---|---|---|---|---|---|
| | | | | | | | | | | Comp | Comp |
| | Ex 1 | Ex 2 | Ex 3 | Ex 4 | Ex 5 | Ex 6 | Ex 7 | Ex 8 | Ex 9 | Ex 1 | Ex 2 |
| Low Shear | 6,974 | 3,815 | 7,366 | 6,458 | 3,616 | 3,789 | 7,970 | 4,807 | 4,953 | 41,242 | 17,167 |
| Viscosity | | | | | | | | | | | |
| (Cp @ | | | | | | | | | | | |
| 1 Hz) | | | | | | | | | | | |
| Tan δ | 0.38 | 0.20 | 0.35 | 0.24 | 0.40 | 0.44 | 0.40 | 0.42 | 0.46 | 0.14 | 0.22 |
| (G″/G′) | | | | | | | | | | | |
| Complex | 52,477 | 9,834 | 99,716 | 30,707 | 8,145 | 8,960 | 58,330 | 14,457 | 69,382 | 691,100 | 650,920 |
| Viscosity | | | | | | | | | | | |
| (mPa · s) | | | | | | | | | | | |
| pH | 10.4 | 9.3 | 8.6 | 9.3 | 9.4 | 8.4 | 9.8 | 9.2 | 8.9 | | 7.3 |
| Days | 222 | 93 | 92 | 130 | 32 | 201 | 99 | 212 | 63 | <2 weeks | 28 |

To summarize, embodiments of a drag reducing slurry comprises polymer particles having drag reducing properties, each particle having a surface that has at least two different polarities, a first surfactant, a second surfactant, a rheological modifier, a defoamer, a pH modifier, and a carrier fluid, wherein the first surfactant has a higher polarity than the second surfactant.

In some of the preceding embodiments, each particle further comprises a core polymer particle, and a coating partially covering the core polymer particle, wherein the surface of each polymer particle comprises a first area occupied by the coating and a second area that an exposed surface of the core polymer particle.

In some of the preceding embodiments, the first area has a higher polarity that the second area.

In some of the preceding embodiments, the first surfactant contacts the first area and the second surfactant contacts the second area.

In some of the preceding embodiments, the first surfactant and the second surfactant, independently, having hydrophilic-lipophilic balance (HLB) values ranging from 4 to 15.

In some of the preceding embodiments, the first and second surfactant have a combined hydrophilic-lipophilic balance (HLB) value ranging from 10-12, where the combined HLB value is a weighted average of the HLB values of the first and second surfactants.

In some of the preceding embodiments, the slurry has a pH ranging from about 6 to about 11.

In some of the preceding embodiments, the slurry has a pH ranging from about 8 to about 11.

In some of the preceding embodiments, the polymer particles are present in the slurry in an amount of 0.05 wt % to 75 wt %, or an amount of 0.1 wt % to 50 wt %, or an amount of 25 wt % to 45 wt %, based on the total weight of the slurry.

In some of the preceding embodiments, the first surfactant is present in the slurry in an amount of 0.1 wt % to 1.0 wt %, based on the total weight of the slurry.

In some of the preceding embodiments, the second surfactant is present in the slurry in an amount of 0.1 wt % to 1.0 wt %, based on the total weight of the slurry.

In some of the preceding embodiments, the defoamer is present in the slurry in an amount of 0.01 wt % to 10 wt %, or an amount of 0.2 wt % to 1.0 wt %, based on the total weight of the slurry.

In some of the preceding embodiments, the polymer particles have an D50 particle diameter ranging from 50 μm to 750 μm.

In some of the preceding embodiments, the polymer particles have an D50 particle diameter ranging from 100 μm to 250 μm.

In some of the preceding embodiments, the polymer particles have particle size distribution ranging from 200 μm to 400 μm of the D50 particle diameter.

In some of the preceding embodiments, the polymer particles comprise polyalpha olefin.

In some of the preceding embodiments, the slurry has a low shear viscosity, measured at 1 Hz, of less than 10,000 centipoise (cP).

In some of the preceding embodiments, the slurry has a low shear viscosity, measured at 1 Hz, between about 2,000 centipoise (cP) to about 8,000 cP.

In some of the preceding embodiments, the slurry has a tan δ of less than 0.5.

In some of the preceding embodiments, the slurry has a tan δ ranging from 0.15 to 0.4.

In some of the preceding embodiments, the slurry has a stability of at least 90 days.

In some of the preceding embodiments, the slurry has a stability of at least 130 days.

In some of the preceding embodiments, the slurry has a complex viscosity less than 100,000 mP·s.

In some of the preceding embodiments, the slurry has a complex viscosity ranging from about 10,000 mP·s to about 70,000 mP·s.

In some of the preceding embodiments, the carrier fluid comprises water.

In some of the preceding embodiments, water is included in the carrier fluid in an amount ranging from about 40 wt % to about 90 wt %, or from about 50 wt % to about 80 wt %, or from about 50 wt % to about 70 wt %, based on the total weight of the carrier fluid.

In some of the preceding embodiments, the carrier fluid comprises a water-soluble solvent.

In some of the preceding embodiments, water-soluble solvent is included in the carrier fluid in an amount ranging from about 5 wt % to about 50 wt %, or from about 5 wt % to about 30 wt %, based on the total weight of the carrier fluid.

In some of the preceding embodiments, the rheology modifier is present in an amount ranging from about 0.05 wt % to about 10 wt %, or from about 0.5 wt % to about 5 wt %, or about 0.07 to about 0.11 wt %, based on the total weight of the slurry.

In some of the preceding embodiments, the carrier fluid is present in an amount of about 50 wt % to about 80 wt %, based on the total weight of the slurry.

In some of the preceding embodiments, the slurry further comprises a biocide.

In some embodiments, a drag reducing slurry comprises polyalpha olefin (PAO) polymer particles, each particle having a surface that has at least two different polarities, a first surfactant, a second surfactant, a rheological modifier, a defoamer, a pH modifier; and a carrier fluid, wherein the carrier fluid comprises water, wherein the water is present in an amount of 50 wt % to 100 wt % based on the total weight of the carrier fluid, wherein the first surfactant has a higher polarity than the second surfactant, wherein the first surfactant is present in an amount of 0.1 wt % to 10 wt %, wherein the second surfactant is present in an amount of 0.1 wt % to 10 wt %, wherein the defoamer is present in an amount of 0.2 to 1.0 wt %, based on the total weight of the slurry, wherein the slurry has a pH ranging from 8 to 11.

In some of the preceding embodiments, the first and second surfactant have a combined hydrophilic-lipophilic balance (HLB) value ranging from about 8 to about 12.5, preferably from about 10 to about 12, where the combined HLB value is a weighted average of the HLB values of the first and second surfactants.

In some of the preceding embodiments, the slurry has a low shear viscosity, measured at 1 Hz, of less than 10,000 centipoise (cP), a tan δ of less than or equal to 0.5, a complex viscosity less than 100,000 mP·s, and a stability of at least 90 days.

In some of the preceding embodiments, the slurry has a low shear viscosity, measured at 1 Hz, between about 2,000 centipoise (cP) to about 8,000 cP, a tan δ ranging from 0.15 to 0.4, preferably 0.2 to 0.5, a complex viscosity ranging from about 10,000 mP·s to about 70,000 mP·s, and a stability of at least 130 days.

In some of the preceding embodiments, each PAO polymer particle further comprises a core PAO particle, and a coating partially covering the core PAO particle, wherein the surface of each PAO polymer particle comprises a first area occupied by the coating and a second area that an exposed surface of the core polymer particle, wherein the first area has a higher polarity that the second area, and wherein the first surfactant contacts the first area and the second surfactant contacts the second area.

A method of reducing drag in a pipeline carrying hydrocarbons comprises injecting the drag reducing slurry of any of the preceding embodiments into a pipeline, the pipeline having hydrocarbons flowing therethrough.

Modifications, additions, or omissions may be made to the systems, apparatuses, and methods described herein. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended statements to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A drag reducing slurry, comprising:
a plurality of polymer particles having drag reducing properties, each polymer particle comprising a surface that comprises at least two different polarities;
a first surfactant;
a second surfactant;
a rheological modifier;
a defoamer;
a pH modifier; and
a carrier fluid comprising water,
wherein the first surfactant has a higher polarity than the second surfactant.

2. The drag reducing slurry of claim 1, wherein each polymer particle further comprises:
a core polymer particle; and
a coating partially covering the core polymer particle,
wherein the surface of each polymer particle comprises a first area occupied by the coating and a second area that of an exposed surface of the core polymer particle.

3. The drag reducing slurry of claim 2, wherein the first area has a higher polarity than the second area.

4. The drag reducing slurry of claim 3, wherein the first surfactant contacts the first area and the second surfactant contacts the second area.

5. The draft reducing slurry of claim 1, wherein the first surfactant and the second surfactant, independently, comprise hydrophilic-lipophilic balance (HLB) values ranging from 4 to 15.

6. The drag reducing slurry of claim 1, wherein the first and second surfactant comprise a combined hydrophilic-lipophilic balance (HLB) value ranging from about 8 to about 12.5, where the combined HLB value is a weighted average of the HLB values of the first and second surfactants.

7. The drag reducing slurry of claim 1, wherein the slurry has a pH ranging from about 6 to about 11.

8. The drag reducing slurry of claim 1, wherein the slurry has a pH ranging from about 8 to about 11.

9. The drag reducing slurry of claim 1, wherein the plurality of polymer particles are present in the slurry in an amount of 0.05 wt % to 75 wt %, or an amount of 0.1 wt % to 50 wt %, or an amount of 25 wt % to 45 wt %, based on a total weight of the slurry.

10. The drag reducing slurry of claim 1, wherein the first surfactant is present in the slurry in an amount of 0.1 wt % to 1.0 wt %, based on a total weight of the slurry.

11. The drag reducing slurry of claim 1, wherein the second surfactant is present in the slurry in an amount of 0.1 wt % to 1.0 wt %, based on a total weight of the slurry.

12. The drag reducing slurry of claim 1, wherein the defoamer is present in the slurry in an amount of 0.01 wt % to 10 wt %, or an amount of 0.2 wt % to 1.0 wt %, based on a total weight of the slurry.

13. The drag reducing slurry of claim 1, wherein at least one of the plurality of polymer particles has a D50 particle diameter ranging from 50 μm to 750 μm.

14. The drag reducing slurry of claim 1, wherein at least one of the plurality of polymer particles has a D50 particle diameter ranging from 100 μm to 250 μm.

15. The drag reducing slurry of claim 13, wherein the plurality of polymer particles have a particle size distribution ranging from 200 μm to 400 μm of the D50 particle diameter.

16. The drag reducing slurry of claim 1, where the plurality of polymer particles comprise polyalpha olefin.

17. The drag reducing slurry of claim 1, where the slurry has a low shear viscosity, measured at 1 Hz, of less than 10,000 centipoise (cP).

18. The drag reducing slurry of claim 1, where the slurry has a low shear viscosity, measured at 1 Hz, between about 2,000 centipoise (cP) to about 8,000 cP.

19. The drag reducing slurry of claim 1, where the slurry has a tan δ of less than or equal to 0.5.

20. The drag reducing slurry of claim 1, where the slurry has a tan δ ranging from 0.15 to 0.4, preferably ranging from 0.2 to 0.5.

21. The drag reducing slurry of claim 1, wherein the slurry has a complex viscosity less than 100,000 mP·s.

22. The drag reducing slurry of claim 1, wherein the slurry has a complex viscosity ranging from about 10,000 mP·s to about 70,000 mP·s.
